(19) United States
(12) Patent Application Publication
(10) Pub. No.: US 2020/0136678 A1
(43) Pub. Date: Apr. 30, 2020

(54) INFORMATION PROCESSING APPARATUS, CONTROL METHOD, AND CONTROL PROGRAM

(71) Applicant: SHARP KABUSHIKI KAISHA, Sakai City, Osaka (JP)

(72) Inventors: NAOKI SHIOBARA, Sakai City, Osaka (JP); MASAFUMI UENO, Sakai City, Osaka (JP); MASAAKI MORIYA, Sakai City, Osaka (JP)

(21) Appl. No.: 16/618,706

(22) PCT Filed: Apr. 12, 2018
(86) PCT No.: PCT/JP2018/015424

§ 371 Date: Dec. 2, 2019

(30) Foreign Application Priority Data
Jun. 6, 2017 (JP) 2017-111650

(51) Int. Cl. H04B 5/00; G06K 19/077; G06K 19/07; G06K 7/10; H01Q 1/22; H04W 4/80

(52) U.S. Cl. CPC H04B 5/0062; H04B 5/0031; G06K 19/07773; H04W 4/80; G06K 7/10356; H01Q 1/2216; G06K 19/0724

(57) ABSTRACT

An information processing apparatus more reliably performs communications with an information communication terminal. The information processing apparatus includes NFC antennas that perform near field communication with an NFC tag and an NFC control unit that controls a sequential order in accordance with which the NFC antennas are scanned.

### TECHNICAL FIELD

The disclosure relates to an information processing apparatus including multiple antennas used to perform near field communication with an information communication terminal.

### BACKGROUND ART

A variety of techniques related to near field communication (NFC) have been recently disclosed. As disclosed in PTL 1, some of information processing apparatuses performing the near field communication include multiple antennas that perform the near field communication with an information communication terminal. Such information processing apparatuses need a controller that drives the antennas. If a controller is used for each antenna, the information processing apparatus becomes costly. In accordance with the technique disclosed in PTL 1, a single controller successively scans the antennas for the near field communication.

### CITATION LIST

### Patent Literature

PTL 1: Japanese Unexamined Patent Application Publication No. 2016-177814 (published Oct. 6, 2016)

### SUMMARY OF INVENTION

### Technical Problem

In accordance with the technique disclosed in PTL 1, since the antennas are sequentially driven, it takes time to detect an information communication terminal. This leads to a problem that communications with the information communication terminal are difficult.

The disclosure in an aspect is intended to provide an information processing apparatus that more reliably performs communications with the information communication terminal and a control method of the information processing apparatus.

### Solution to Problem

To solve the problem, an information processing apparatus in an aspect of the disclosure has a plurality of antennas used to perform near field communication with an information communication terminal and includes a scan controller that controls a sequential order in accordance with which the antennas are scanned.

To solve the problem, a control method in an aspect of the disclosure is a control method performed by an information processing apparatus with a plurality of antennas used to perform near field communication with an information communication terminal and includes a scan control step that controls a sequential order in accordance with which the antennas are scanned.

### Advantageous Effects of Invention

The disclosure in an aspect provides the advantage that communications performed with an information communication terminal are more reliably performed.

### BRIEF DESCRIPTION OF DRAWINGS

FIG. 1 is a block diagram illustrating a configuration of major elements of an information processing apparatus of a first embodiment.

FIG. 2 is an exploded perspective view illustrating a configuration of an NFC display included in the information processing apparatus.

FIG. 3 is a plan view of the NFC display.

FIG. 4 is a flowchart illustrating an example of a control operation of a scanning sequential order of NFC antennas included in the information processing apparatus.

FIG. 5 is a plan view illustrating a configuration of the NFC display included in an information processing apparatus as a modification of the above-described information processing apparatus.

FIG. 6 illustrates an information processing apparatus as a second embodiment.

FIG. 7 illustrates an example of an operation of an information processing apparatus of a third embodiment.

FIG. 8(a) illustrates a position of an NFC tag at a given scan timing of the information processing apparatus, FIG. 8(b) illustrates of a position of the NFC tag at the next scan timing subsequent to the scan timing in FIG. 8(a) when an adjacent NFC antenna is scanned in a forward direction, and FIG. 8(c) illustrates a position of the NFC tag at the next scan timing subsequent to the scan timing in FIG. 8(a) when a non-adjacent NFC antenna is scanned in the forward direction.

FIGS. 9(a) and 9(b) illustrate the NFC tag in the information processing apparatus when the NFC tag moves in a direction opposite from a scan direction with respect to the NFC antenna.

FIG. 10 illustrates an information processing apparatus of a modification of the above-described information processing apparatus.

### DESCRIPTION OF EMBODIMENTS

### First Embodiment

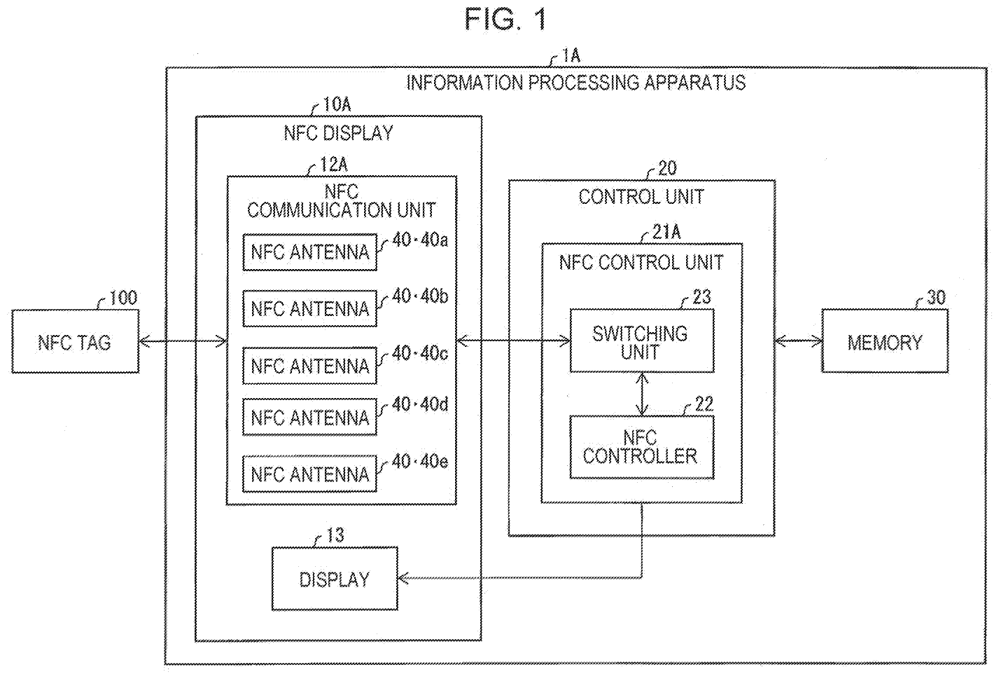

A first embodiment is described in detail with reference to FIGS. 1 through 4. In the description, the term “near field communication” broadly means radio communication having a short communication range. The near field communication includes communication that is based on RFID (Radio Frequency IDentification) technique, such as non-contact IC (Integrated Circuit) card or non-contact IC tag. In the description, the word “communication” is intended to mean the near field communication unless otherwise particularly noted. In embodiments described below, an example of the near field communication is NFC (Near Field Communication).

### (Information Processing Apparatus 1A)

An information processing apparatus 1A of a first embodiment is described below. FIG. 1 is a block diagram illustrating a configuration of major elements of the information processing apparatus 1 of the first embodiment.

The information processing apparatus 1A is an apparatus that communicates with an information communication terminal (an NFC tag 100 in the first embodiment). Referring to FIGS. 1 through 3, the information processing apparatus 1A includes an NFC display 10A, control unit 20, and memory 30.

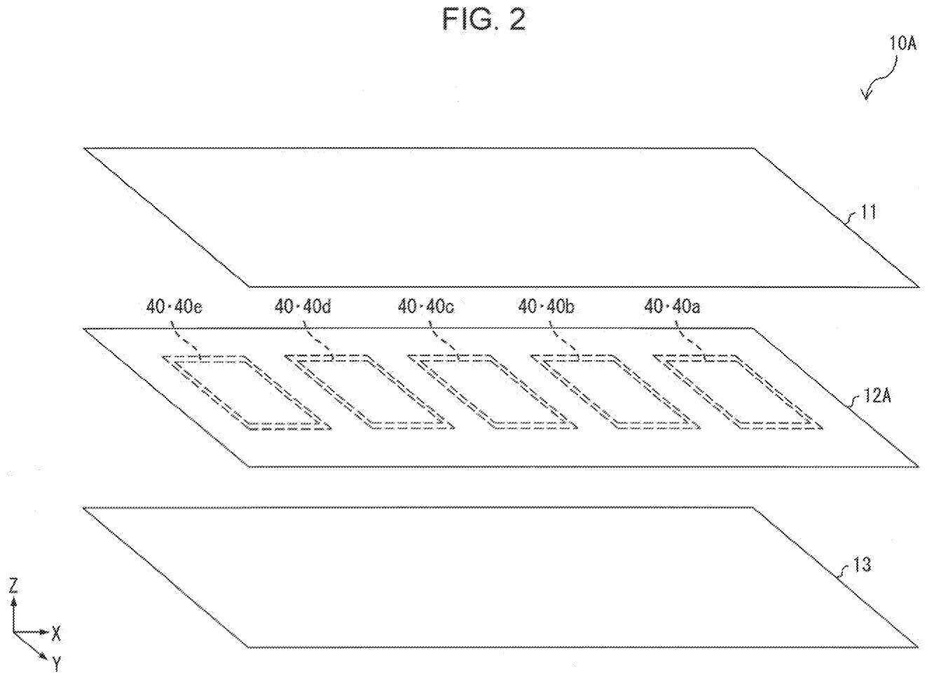

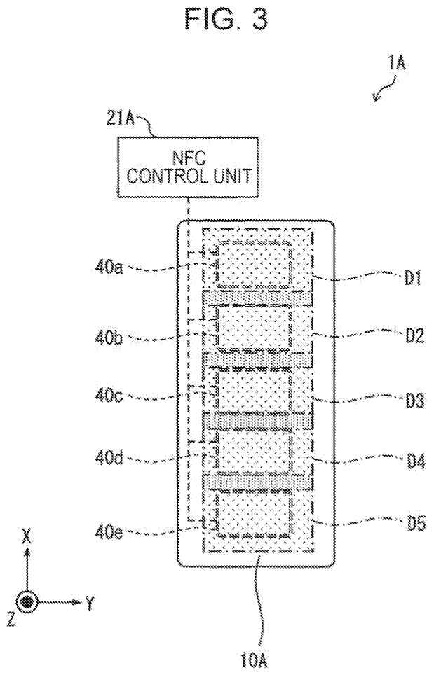

FIG. 2 is an exploded perspective view illustrating the configuration of the NFC display 10A included in the information processing apparatus 1A. FIG. 3 is a plan view of the NFC display 10A.

Referring to FIGS. 1 through 3, the NFC display 10A includes a protective glass plate 11, NFC communication unit 12A, and display 13 stacked on top of one another in this order as a unitary body.

An NFC communication unit 12A is a communication device that is used when the information processing apparatus 1A communicates with the NFC tag 100. The NFC communication unit 12A is a sheet member that is arranged between the protective glass plate 11 and display 13. The NFC communication unit 12A includes five NFC antennas 40 (antennas). The NFC antennas 40 are referred to as NFC antennas 40a through 40e to differentiate one NFC antenna 40 from another.

The NFC antenna 40 has a function of detecting the NFC tag 100 and transmitting or receiving data to or from the NFC tag 100. The NFC communication unit 12A in the first embodiment includes the NFC antennas 40a through 40e that are linearly and regularly arranged side by side in one direction (X direction). The driving of the NFC antennas 40 is controlled by the NFC control unit 21A.

In the discussion of the first embodiment, an object that is held over the NFC antenna 40 is the NFC tag 100. The object to be held over the NFC antenna 40 may be an object other than the NFC tag 100. Specifically, the object may be a terminal including an antenna for NFC (for example, a mobile information terminal, such as mobile multi-purpose phone (smart phone)). The NFC tag 100 and the terminal may also be referred to as an NFC terminal.

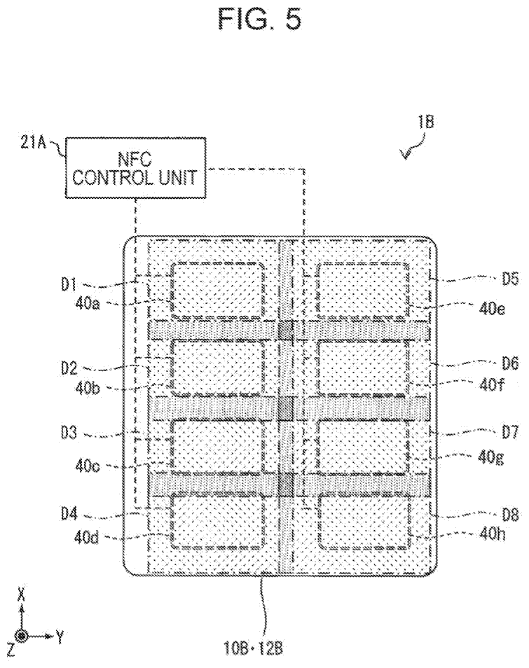

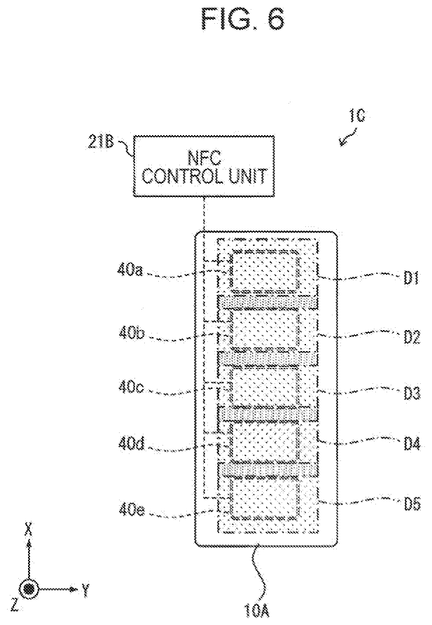

A communication area within which each of the NFC antennas 40a through 40e is communicable with the NFC tag 100 (hereinafter referred to as a communication coverage area) is described below with reference to FIG. 3. Referring to FIG. 3, the NFC antennas 40a through 40e have respectively communication coverage areas D1 through D5. Referring to FIG. 3, each region where the communication coverage areas of the NFC antennas 40 overlap each other is represented by increasing the density of dots (the same is true of FIG. 5 and FIG. 6).

The information processing apparatus 1A of the first embodiment in FIG. 3 includes the communication coverage areas D1 through D5 of the NFC antennas 40 with the coverage area of an NFC antenna 40 partially overlapping the coverage area of an adjacent antenna 40. For example, the communication coverage area D1 of the NFC antenna 40a partially overlaps the communication coverage area D2 of the NFC antenna 40b.

The display 13 is a display device having an image display function that displays, as an image, information to be processed by the information processing apparatus 1A (specifically, the control unit 20 described below). The display 13 includes but is not limited to an LCD (Liquid Crystal Display).

The control unit 20 integrally controls elements of the information processing apparatus 1A. Specifically, the control unit 20 controls the display 13 and the NFC antenna 40 and starts up or controls software (application) stored on the memory 30. The control unit 20 includes the NFC control unit 21A (scan controller).

The NFC control unit 21A controls the NFC antennas 40. The NFC control unit 21A includes an NFC controller 22 and a switching unit 23.

The NFC controller 22 output to the switching unit 23 an instruction as to which of the NFC antenna 40 of the NFC antennas 40a through 40e is to be connected to the NFC controller 22.

The switching unit 23 is connected to the NFC antennas 40a through 40e. In response to the instruction from the NFC controller 22, the switching unit 23 connects one NFC antenna 40 of the NFC antennas 40a through 40e to the NFC controller 22.

The NFC controller 22 periodically varies the magnitude of a radio signal (namely, a magnetic field) emitted from one NFC antenna 40 of the NFC antennas 40a through 40e connected by the switching unit 23 and confirms the presence of the NFC tag 100 in the vicinity of the NFC antenna 40. Specifically, the NFC controller 22 scans one NFC antenna 40 of the NFC antennas 40a through 40e (in an operative state). This operation is referred to as polling.

If the NFC tag 100 is positioned in the vicinity of the NFC antenna 40, the magnetic field varies in response to the polling and a current is induced in an NFC communication antenna (not illustrated) housed in the NFC tag 100. An IC chip (not illustrated) housed in the NFC tag 100 is started up in response to the induced current. As a result, the NFC controller 22 allows a variety of information to be wirelessly exchanged between the NFC antenna 40 and the NFC tag 100 (specifically, IC chip). The NFC controller 22 wirelessly receives (acquires) information (for example, terminal information) from the NFC tag 100.

The memory 30 stores a variety of control programs that are executed by the control unit 20 and, for example, includes a memory device, such as a hard disk or a flash memory.

### (Control of Scanning Sequential Order of NFC Antennas)

A control method (scan control step) of a scanning sequential order of the NFC antennas 40a through 40e of the first embodiment is described below.

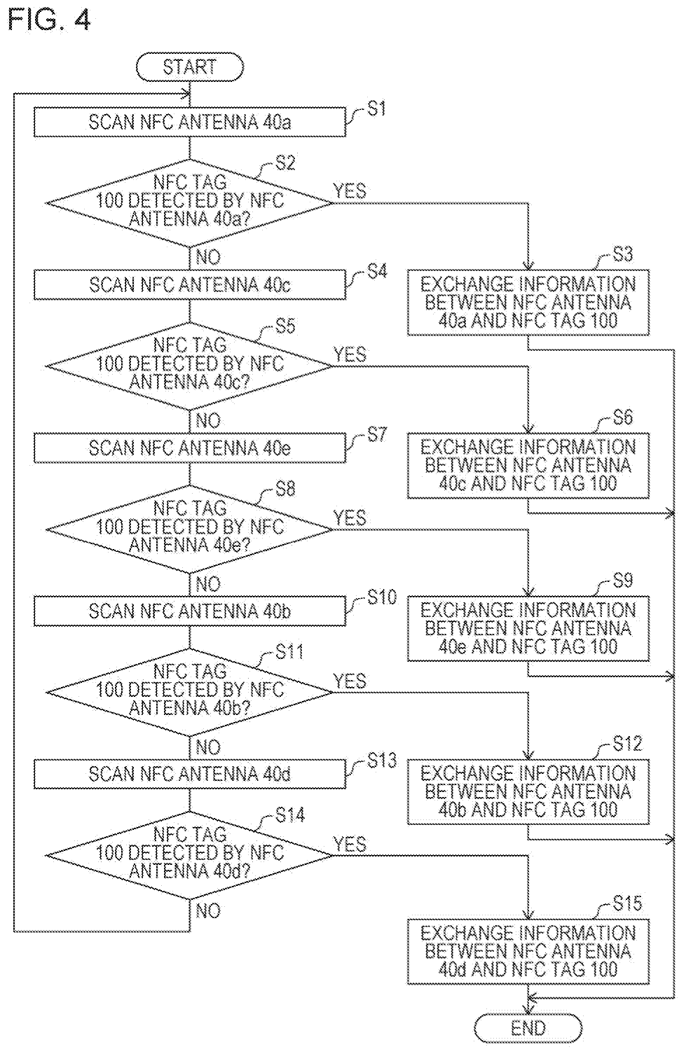

The NFC control unit 21A in the information processing apparatus 1A controls the scanning sequential order of the NFC antennas 40a through 40e such that the communication coverage area of the NFC antenna 40 that is currently being scanned does not overlap the communication coverage area of the NFC antenna 40 that has been scanned immediately before. The control example of the scanning sequential order of the NFC antennas 40 controlled by the NFC control unit 21A is described below with reference to FIGS. 3 and 4. FIG. 4 is a flowchart illustrating the control example of the scanning sequential order of the NFC antennas 40 controlled by the NFC control unit 21A.

For convenience of explanation, the NFC antenna 40a through the NFC antenna 40e are respectively referred to as “a” through “e” in the discussion of the scanning sequential order.

Referring to FIG. 4, the NFC control unit 21A causes the NFC antennas 40 to be scan in the sequential order “a→c→e→b→d”.

Specifically, the NFC control unit 21A scans the NFC antenna 40a (S1). The NFC control unit 21A determines whether the NFC antenna 40a has detected the NFC tag 100 (S2). If the NFC antenna 40a has detected the NFC tag 100 (yes path from S2), the NFC control unit 21A exchanges information between the NFC antenna 40a and the NFC tag 100 (S3).

If the NFC antenna 40a has not detected the NFC tag 100 (no path from S2), the NFC control unit 21A scans the NFC antenna 40c (S4). Referring to FIG. 3, the communication coverage area D1 of the NFC antenna 40a does not overlap the communication coverage area D3 of the NFC antenna 40c. The NFC control unit 21A determines whether the NFC antenna 40c has detected the NFC tag 100 (S5). If the NFC antenna 40c has detected the NFC tag 100 (yes patch from step S5), the NFC control unit 21A exchanges information between the NFC antenna 40c and the NFC tag 100 (S6).

If the NFC antenna 40c has not detected the NFC tag 100 (no path from S5), the NFC control unit 21A scans the NFC antenna 40e (S7). Referring to FIG. 3, the communication coverage area D3 of the NFC antenna 40c does not overlap the communication coverage area D5 of the NFC antenna 40e. The NFC control unit 21A determines whether the NFC antenna 40e has detected the NFC tag 100 (S8). If the NFC antenna 40e has detected the NFC tag 100 (yes path from S8), the NFC control unit 21A exchanges information between the NFC antenna 40e and the NFC tag 100 (S9).

If the NFC antenna 40e has not detected the NFC tag 100 (no path from S8), the NFC control unit 21A scans the NFC antenna 40b (S10). Referring to FIG. 3, the communication coverage area D5 of the NFC antenna 40e does not overlap the communication coverage area D2 of the NFC antenna 40b. The NFC control unit 21A determines whether the NFC antenna 40b has detected the NFC tag 100 (S11). If the NFC antenna 40b has detected the NFC tag 100 (yes path from S11), the NFC control unit 21A exchanges information between the NFC antenna 40b and the NFC tag 100 (S12).

If the NFC antenna 40b has not detected the NFC tag 100 (no path from S11), the NFC control unit 21A scans the NFC antenna 40d (S13). Referring to FIG. 3, the communication coverage area D2 of the NFC antenna 40b does not overlap the communication coverage area D4 of the NFC antenna 40d. The NFC control unit 21A determines whether the NFC antenna 40d has detected the NFC tag 100 (S14). If the NFC antenna 40d has detected the NFC tag 100 (yes path from S14), the NFC control unit 21A exchanges information between the NFC antenna 40d and the NFC tag 100 (S12). On the other hand, if the NFC antenna 40d has not detected the NFC tag 100 (no path from S14), the NFC control unit 21A returns to step S1 to repeat the routine described above.

If the NFC antenna 40a, the NFC antenna 40b, the NFC antenna 40c, the NFC antenna 40d, and the NFC antenna 40e are scanned in this order (namely, in the order of arrangement of the NFC antennas 40a through 40e), the communication coverage area of the NFC antenna 40 currently being scanned overlaps the communication coverage area of the NFC antenna 40 scanned immediately before. As a result, the detection area in which the two NFC antennas 40 is able to detect the NFC tag 100 is reduced. For this reason, time for the information processing apparatus 1A to detect the NFC tag 100 is prolonged.

In contrast, the information processing apparatus 1A of the first embodiment, the NFC control unit 21A controls the scanning sequential order of the NFC antennas 40a through 40e such that the communication coverage area of the NFC antenna 40 currently being scanned does not overlap the communication coverage area of the NFC antenna 40 scanned immediately before (in other words, the overlapping area is minimized). In this way, the detection area in which the two NFC antennas 40 is able to detect the NFC tag 100 is increased. As a result, the possibility that the information processing apparatus 1A detects the NFC tag 100 is increased and the possibility that the NFC tag 100 is detected earlier is increased. In other words, the communications between the information processing apparatus 1A and the NFC tag 100 are more reliably carried out.

An example of the scanning sequential order of the NFC antennas 40 has been described above. In accordance with an aspect of the disclosure, the NFC control unit 21A may scan the NFC antennas 40 in the order “a→d→b→e→c”. In such a case, the communication coverage area of the NFC antenna 40 currently being scanned may be designed not to overlap the communication coverage area of the NFC antenna 40 scanned immediately before.

The first embodiment is configured such that the NFC control unit 21A includes the single NFC controller 22. In one aspect of the disclosure, the NFC control unit 21A includes multiple NFC controllers 22 (for example, two NFC controllers 22) and the NFC controllers 22 simultaneously scan multiple NFC antennas 40. In such a case, as well, each of the NFC controllers 22 controls the scanning sequential order of the NFC antennas 40 such that the communication coverage area of the NFC antenna 40 currently being scanned does not overlap the communication coverage area of the NFC antenna 40 scanned immediately before. This may increase the possibility that the information processing apparatus 1A detects the NFC tag 100 earlier. At each timing, the communication coverage areas of the NFC antennas 40 scanned by the NFC controllers 22 are desirably not overlapped. In this way, the area where the information processing apparatus 1A detects the NFC tag 100 is increased. The possibility that the information processing apparatus 1A detects the NFC tag 100 earlier is thus increased.

If the NFC control unit 21A includes multiple NFC controllers 22 (for example, two NFC controllers 22), the NFC controllers 22 may be respectively arranged for the switching units 23 or the single switching unit 23 may connect the NFC controllers 22 to the NFC antennas 40. If the NFC control unit 21A includes multiple NFC controllers 22 (for example, two NFC controllers 22), the positions of the NFC antennas 40 or the communication timings of the NFC antennas 40 with the NFC tag 100 are shifted such that the signals from the NFC antenna 40 connected to the NFC controllers do not interfere with each other as a noise.

### FIRST MODIFICATION

An information processing apparatus 1B is described below as a first modification of the information processing apparatus 1A of the first embodiment with reference to FIG. 5.

FIG. 5 is a plan view illustrating the configuration of an NFC display 10B included in the information processing apparatus 1B as the first modification.

Referring to FIG. 5, the NFC display 10B includes the NFC communication unit 12B in place of the NFC communication unit 12A in the NFC display 10A of the first embodiment.

The NFC communication unit 12B includes eight NFC antennas 40 (NFC antennas 40a through 40h). The NFC antennas 40a through 40d are arranged side by side in one direction (X axis direction) and the NFC antennas 40e through 40h are arranged side by side in one direction (X axis direction). One column including the NFC antennas 40a through 40d and the other column including the NFC antennas 40e through 40h are arranged side by side in a Y axis direction.

Referring to FIG. 5, among communication coverage areas D1 through D8 of the NFC antennas 40, one communication coverage area partially overlaps another communication coverage area adjacent thereto. For example, the communication coverage area D2 of the NFC antenna 40b partially overlaps the communication coverage area D1 of the NFC antenna 40a, the communication coverage area D3 of the NFC antenna 40c, the communication coverage area D5 of the NFC antenna 40e, the communication coverage area D6 of the NFC antenna 40f, and the communication coverage area D7 of the NFC antenna 40g.

An example of a control method of the scanning sequential order of the NFC antennas 40 of the first modification is described below. In accordance with the first modification, the NFC control unit 21A scans the NFC antennas 40 in the order “a→c→e→g→b→d→f→h”. In this way, when NFC antennas are scanned from the NFC antenna 40g to the NFC antenna 40b, the communication coverage area D7 of the NFC antenna 40g partially overlaps the communication coverage area D2 of the NFC antenna 40b. In the rest of the scanning, however, the communication coverage area 40 that is currently being scanned does not overlap the communication coverage area of the NFC antenna 40 that has been scanned immediately before. The NFC control unit 21A in the information processing apparatus 1B controls the scanning sequential order of the NFC antennas 40 such that an overlapping area between the communication coverage area of the NFC antenna 40 currently being scanned and the communication coverage area of the NFC antenna 40 scanned immediately before is minimized. This arrangement may increase the possibility that the information processing apparatus 1B detects the NFC tag 100 earlier.

### SECOND EMBODIMENT

A second embodiment of the disclosure is described with reference to FIG. 6. For convenience of explanation, elements having the same functions as elements described with reference to the first embodiment are designated with the same reference numerals and the discussion thereof is omitted herein.

An information processing apparatus IC of the second embodiment is described below. FIG. 6 illustrates the information processing apparatus LC.

The information processing apparatus 1C includes the NFC control unit 21B in place of the NFC control unit 21A of the first embodiment. In the information processing apparatus 1A of the first embodiment, the NFC control unit 21B controls the scanning sequential order of the NFC antennas 40 such that the frequencies of scanning of the NFC antennas 40 are equalized. In contrast, the NFC control unit 21B in the information processing apparatus 1C of the second embodiment controls the scanning sequential order of the NFC antennas 40 by beforehand setting the frequency of scanning of each NFC antenna 40.

Specifically, the NFC control unit 21B has also a function of a frequency-of-scanning determination unit that determines a frequency of scanning of the NFC antennas 40a through 40e. Note that the NFC control unit 21B and the frequency-of-scanning determination unit may be separate function units. The NFC control unit 21B controls the scanning sequential order of the NFC antennas 40a through 40e in accordance with the frequencies of scanning of the NFC antennas 40a through 40e determined by the NFC control unit 21B.

The method of how the NFC control unit 21B determines the frequencies of scanning of the NFC antennas 40a through 40e is not limited to any particular method. For example, the NFC control unit 21B may determine the frequency of scanning of each NFC antenna 40 in accordance with the frequency of communications of the NFC tag 100 performed throughout the period of time from the startup of the information processing apparatus 1C to the present time. Specifically, the NFC control unit 21B may determine the frequency of scanning of each NFC antenna 40 such that the frequency of scanning of an NFC antenna 40 having a higher frequency of communications is higher while the frequency of scanning of an NFC antenna 40 having a lower frequency of communications is lower. In this way, the possibility that the NFC tag 100 is detected earlier is increased.

Another method of how the NFC control unit 21B determines the frequencies of scanning of the NFC antennas 40a through 40e is described. If a specific NFC antenna 40 is expected to have a higher frequency of communications (frequency of use) with the NFC tag 100, the NFC control unit 21B may set the frequency of scanning of that NFC antenna 40 to be higher. For example, products may be respectively assigned to the NFC antennas 40 and the product assigned to a specific NFC antenna 40 may be known to be more popular. In such a case, that antenna has a higher frequency of communications with the NFC tag 100.

Another method of how the NFC control unit 21B determines the frequencies of scanning of the NFC antennas 40a through 40e is further described. The frequency of scanning of each NFC antenna 40 may be determined depending on the application of each NFC antenna 40. Specifically, electronic payment may be performed using the NFC antenna 40a and information may be acquired using the NFC antenna 40b. The NFC control unit 21B may determine the frequency of scanning of each NFC antenna 40 such that the frequency of scanning of the NFC antenna 40a having a higher priority is set to be higher than the frequency of scanning of the NFC antenna 40b.

A control method of the scanning sequential order of the NFC antennas 40a through 40e of the second embodiment is described below. For example, the NFC control unit 21B may now determine the frequency of scanning of the NFC antennas 40a through 40e such that the NFC antenna 40a has a ratio of 5, the NFC antenna 40b has a ratio of 1, the NFC antenna 40c has a ratio of 2, the NFC antenna 40d has a ratio of 2, and the NFC antenna 40e has a ratio of 3 in terms of the frequency of scanning.

If the frequency of scanning is determined as described above, the NFC control unit 21B scans the NFC antennas 40, namely serially scans the NFC antennas 40a through 40e in the order “a→a→a→a→a→b→c→c→d→d→e→e→e”. This scanning sequential order is effective if a specific NFC antenna 40 is desirably scanned.

The NFC control unit 21B may scan the NFC antennas 40, for example, may non-serially scan the NFC antennas 40a through 40e in the order “a→e→a→c→d→a→e→b→a→c→d→a→e”. The scanning sequential order is particularly effective if the NFC antenna 40 having a longer time elapse from the last scanning is desirably scanned.

The NFC control unit 21B may scan the NFC antennas 40, for example, may non-serially scan the NFC antennas 40a through 40e in the order “a→c→a→d→a→e→c→a→d→b→e→a→e” in a manner such that the communication coverage area of the NFC antenna 40 that is currently being scanned does not overlap the communication coverage area of the NFC antenna 40 that has been scanned immediately before.

As described above, the NFC control unit 21B in the information processing apparatus IC of the second embodiment determines the frequency of scanning of each NFC antenna 40 by accounting for the applications and usage status of the information processing apparatus IC. The NFC control unit 21B controls the scanning sequential order of each NFC antenna 40 in accordance with the determined frequency of scanning. In this way, the possibility that the information processing apparatus 1C detects the NFC tag 100 is increased and the possibility that the NFC tag 100 is detected earlier is increased. In other words, the communications between the information processing apparatus 1C and the NFC tag 100 are more reliably performed.

If multiple NFC antennas 40 (two or more NFC antennas 40) are simultaneously scanned at a single scanning timing, the NFC control unit 21B may continuously scan the NFC antenna 40 (a specific NFC antenna 40) having the highest frequency of communications with the NFC tag 100 from among the NFC antennas 40a through 40e. The NFC control unit 21B may thus determine the frequency of scanning of each NFC antenna excluding the specific NFC antenna and may control the scanning sequential order of each NFC antenna 40 in accordance with the determined frequency of scanning.

The NFC control unit 21B may determine the frequency of scanning by accounting for the usage statue of the information processing apparatus 1C. Specifically, the NFC antenna 40a may perform individual authentication (log-in) and the NFC antenna 40b may perform a process subsequent to the individual authentication. In such a case, the NFC antenna 40b is not used at the beginning of an operation. For this reason, the probability that the NFC antenna 40b is used is expected to be lower if the NFC antenna 40a has not communicated with the NFC tag 100 for a predetermined period of time. In such a case, the NFC control unit 21B may set the frequency of scanning of the NFC antenna 40b to be lower.

If the information processing apparatus 1C is used by a single person only and the NFC antenna 40a is used at a given moment, the possibility that an NFC antenna 40 (for example, the NFC antenna 40e) positioned farther from the NFC antenna 40a is used is expected to be lower. In such a case, the NFC control unit 21B may set the frequency of scanning of the NFC antenna 40b positioned farther from the NFC antenna 40a to be lower.

If the information processing apparatus LC is used by multiple persons and the NFC antenna 40a is used at a given moment, the possibility that an NFC antenna 40 (for example, the NFC antenna 40e) positioned farther from the NFC antenna 40a is used is expected to be higher. In such a case, the NFC control unit 21B may set the frequency of scanning of the NFC antenna 40 positioned farther from the NFC antenna 40a to be higher.

### THIRD EMBODIMENT

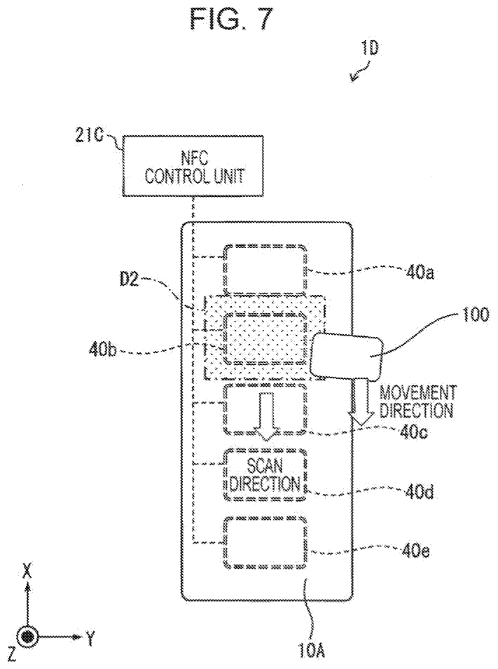

A third embodiment of the disclosure is described below with reference to FIGS. 7 through 10. FIG. 7 illustrates an example of the operation of an information processing apparatus 1D of the third embodiment. For convenience of explanation, the information processing apparatus 1D of the third embodiment includes the NFC display 10A illustrated in FIG. 3.

The information processing apparatus 1D includes an NFC control unit 21C (estimator) in place of the NFC control unit 21A in the information processing apparatus 1A. The NFC control unit 21C scans the NFC antennas 40a through 40e in response to the direction of movement of the NFC tag 100.

Specifically, the NFC control unit 21C also has a function as the estimator that estimates the direction of movement of the NFC tag 100 (hereinafter referred to as a terminal movement direction). Note that the NFC control unit 21C and the estimator may be arranged as separate function units. The NFC control unit 21C scans the NFC antennas 40a through 40e in accordance with the terminal movement direction estimated thereby.

The method of how the NFC control unit 21C estimates the terminal movement direction is not limited to any particular one. For example, the NFC control unit 21C estimates the terminal movement direction in response to a tendency of a chronological change in the communication position of the NFC tag 100 with respect to each of the NFC antennas 40a through 40e.

For example, concerning the log of communication (hereinafter referred to as a “communication log”) between each of the NFC antennas 40a through 40e with the NFC tag 100, the communications with the NFC tag 100 may now tend to be faster when the NFC antennas are scanned in the order “a→b→c→d→e” than when the NFC antennas are scanned in the order “e→d→c→b→a”. In such a case, the NFC control unit 21C may estimate the direction from the NFC antenna 40a to the NFC antenna 40e (forward direction) to be the terminal movement direction in accordance with the communication log.

The NFC control unit 21C may estimate the terminal movement direction in accordance with not only the communication log but also detection results of a sensor capable of detecting the position of the NFC tag 100. By detecting the position of the NFC tag 100 at a higher accuracy, the terminal movement direction may be more accurately estimated.

As an example, a touch sensor mounted on the NFC display 10A (specifically, the NFC display 10A includes a touch panel) may now be considered. In such a case, the touch sensor may detect a position where the NFC tag 100 touches or is in close proximity with the NFC display 10A. The NFC control unit 21C may thus estimate the terminal movement direction in accordance with the communication log and the detection results (detected position).

The sensor detecting the position of the NFC tag 100 is not limited to the touch sensor (or proximity sensor). For example, an illuminance sensor may be used. The sensor may be any sensor as long as the sensor is able to identify the position of the NFC tag 100 on the NFC display 10A.

The NFC control unit 21C desirably estimates the terminal movement direction as fast as possible. If the NFC control unit 21C estimates the terminal movement direction in accordance with the detection results of the sensor, an amount of communication data is desirably reduced. To this end, the frequency of detection operations of the sensor is desirably more reduced than in ordinary applications. Alternatively, at least the number of sensors or types of sensors mounted on the information processing apparatus 1D may be reduced.

FIG. 7 illustrates an example of an operation in which the NFC tag 100 moves in a forward direction. The NFC control unit 21C may now determine the NFC tag 100 to move in the forward direction as the terminal movement direction. Specifically, the terminal movement direction estimated by the NFC control unit 21C is aligned with the actual terminal movement direction.

The NFC control unit 21C may set the scan direction with reference to the NFC antennas 40a through 40e (the direction in which the NFC control unit 21C scans the NFC antennas 40a through 40e) to be the same direction as the terminal movement direction estimated by the NFC control unit 21C (namely, the forward direction). Specifically, the NFC control unit 21C may scan the NFC antennas 40a through 40e in the order “a→b→c→d→e”.

As an example, FIG. 7 illustrates the operation example in which the NFC tag 100 moving in the forward direction is positioned close to the NFC antenna 40b. In this case, the NFC control unit 21C scans the NFC antenna 40b. In the communication coverage area D2, the NFC tag 100 may communicate with the NFC antenna 40b.

When the NFC tag 100 may move close to the NFC antenna 40c with time, the NFC control unit 21C scans the NFC antenna 40c. In the communication coverage area D3 (not illustrated in FIG. 7), the NFC tag 100 may communicate with the NFC antenna 40c.

The information processing apparatus 1D may scan the NFC antennas 40a through 40e while keeping track of the moving NFC tag 100, the information processing apparatus 1D may more reliably communicate with the NFC tag 100. Furthermore, this arrangement provides the advantage that the communication time between the information processing apparatus 1D and the NFC tag 100 is reduced.

As an example, the information processing apparatus 1D may be used to manage products with the NFC tags 100 attached thereto along a production line in a manufacturing plant. For example, the NFC display 10A may be mounted on a belt conveyor conveying the products in a predetermined direction (forward direction). In this configuration, the products conveyed by the belt conveyor may be managed.

The information processing apparatus 1D may be used in a game machine in which the NFC tag 100 is moved in a predetermined direction in accordance with a video displayed on the NFC display 10A. In this configuration, an operation performed by a user may be more accurately detected.

As described above, the information processing apparatus 1D may scan the NFC antennas 40 in the terminal movement direction. The information processing apparatus 1D is thus appropriately used to keep track of the NFC tag 100 moving on the NFC display 10A.

### (Example of the Scanning Sequential Order of the NFC Antenna)

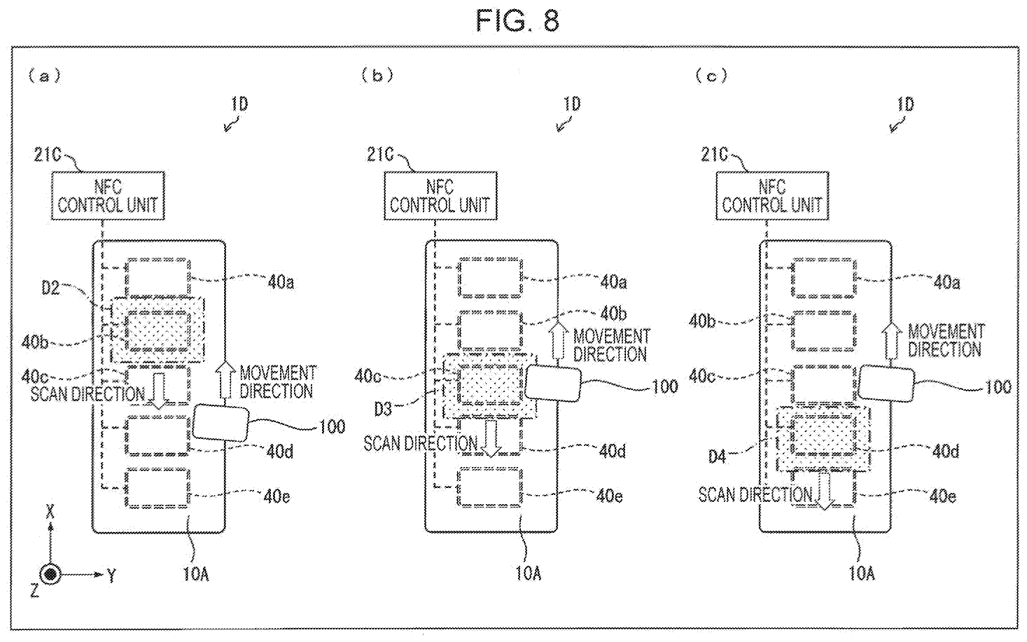

It is contemplated that the NFC tag 100 is temporarily moved in a direction different from a predetermined intended direction (the forward direction). FIGS. 8(a) through 8(c) illustrate cases in which the NFC tag 100 moves in a direction (opposite to the forward direction).

As described above, the NFC control unit 21C may now estimate the terminal movement direction to be the forward direction in FIG. 8. In such a case, the scan direction with respect to the NFC antennas 40a through 40e is opposite to the actual movement direction of the NFC tag 100. In such a case, the NFC tag 100 may possibly pass through the communication coverage areas D1 through D5, depending on the timing of the movement of the NFC tag 100 and the timing of the scanning to the NFC antennas 40a through 40e.

There is a possibility that communication is not reliably performed between the information processing apparatus 1D and the NFC tag 100. There is also a concern that communication time between the information processing apparatus 1D and the NFC tag 100 is prolonged. The scanning sequential order of the NFC antennas 40a through 40e is desirably selected to reduce the possibility that the NFC tag 100 passes through the communication coverage areas D1 through D5.

FIG. 8(a) illustrates the position of the NFC tag 100 at a given scan timing. Referring to FIG. 8(a), the NFC tag 100 may now be positioned close to the NFC antenna 40d when the NFC antenna 40b is scanned.

It is now contemplated that the NFC control unit 21C scans the NFC antennas 40a through 40e in the order “a→b→c→d→e”. In other words, the NFC control unit 21C scans the adjacent NFC antennas 40 in the forward direction.

FIG. 8(b) illustrates the position of the NFC tag 100 at the timing in succession to the timing in FIG. 8(a) when the adjacent NFC antennas 40 are scanned in the forward direction. Referring to FIG. 8(b), as described above, the NFC control unit 21C scans the NFC antenna 40c (adjacent to the NFC antenna 40b).

When the NFC tag 100 moves and is in close proximity with the NFC antenna 40c with time, the NFC tag 100 within the communication coverage area D3 is able to communicate with the NFC antenna 40c. If the NFC antennas 40 are scanned in the forward direction in this way, the possibility that the NFC tag 100 passes through the communication coverage areas D1 through D5 may be reduced. The communications are thus performed between the information processing apparatus 1D and the NFC tag 100.

It is now contemplated that the NFC control unit 21C scans the NFC antennas 40a through 40e in the order “a→c→e→b→d” in the forward direction. In other words, the NFC control unit 21C scans the NFC antennas 40 that are not adjacent to each other (but are spaced from each other).

FIG. 8(c) illustrates the position of the NFC tag 100 at the scan timing subsequent to the timing in FIG. 8(a) when the NFC antennas 40 that are not adjacent to each other are scanned in the forward direction. Referring to FIG. 8(c), not the NFC antenna 40c but the NFC antenna 40d is scanned when the NFC tag 100 moves and is in close proximity with the NFC antenna 40c.

The NFC tag 100 thus passes through the communication coverage area D4. Communication is not established between the NFC tag 100 and the NFC antenna 40d. The communication coverage area D3 is not formed and communication is not established between the NFC tag 100 and the NFC antenna 40c. If the NFC antennas 40 that are not adjacent to each other are scanned in the forward direction, the possibility that the NFC tag 100 passes through the communication coverage areas D1 through D5 is increased.

Referring to FIGS. 7 and 8, the NFC control unit 21C scans a single NFC antenna 40 at a single scan. As described below, however, the NFC control unit 21C may simultaneously scan multiple NFC antennas 40 (two or more NFC antennas 40) at a single scan.

In such a case, in order to reduce the possibility that the NFC tag 100 moving in the opposite direction passes through the communication coverage areas D1 through D5, two adjacent NFC antennas 40 (for example, the NFC antennas 40a and 40b) are desirably simultaneously scanned at a single scan in the forward direction. The possibility that the NFC tag 100 passes through the communication coverage areas D1 through D5 is reduced by scanning in this way more than when two non-adjacent NFC antennas 40 (for example, the NFC antennas 40a and 40c) are simultaneously scanned at a single scan. If three or more NFC antennas 40 are simultaneously scanned, two or more adjacent NFC antennas 40 (the NFC antennas 40a, 40b, and 40c) are simultaneously scanned.

(Another Operation Example in which Multiple NFC Antennas 40 are Simultaneously Scanned)

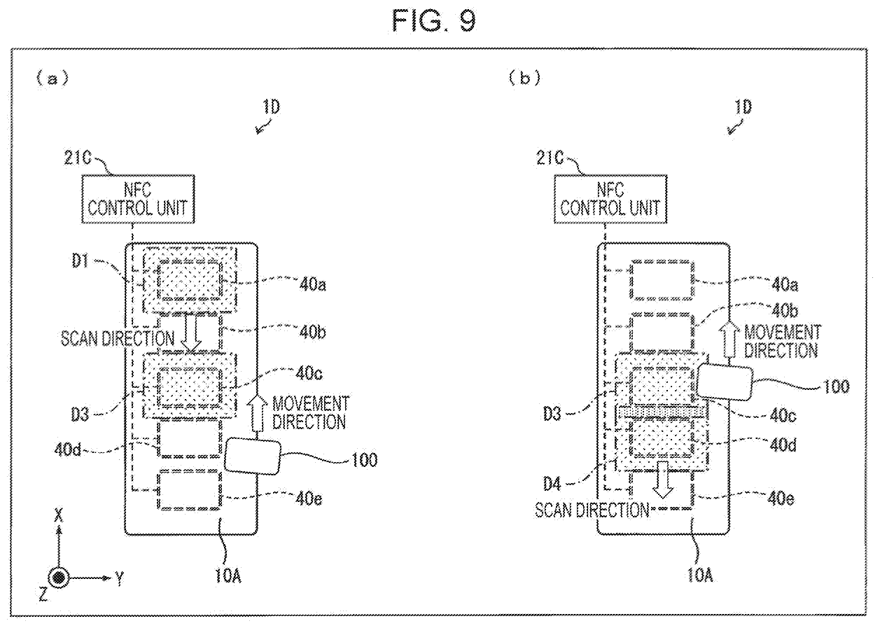

Another operation example in which two NFC antennas 40 are simultaneously scanned is described with reference to FIGS. 9(a) and 9(b). In the same manner as previously described with reference to FIG. 8, the NFC tag 100 moves in the opposite direction in FIG. 9. It is contemplated in this case as well that the NFC control unit 21C has estimated the terminal movement direction to be the forward direction.

Referring to FIG. 9, the NFC control unit 21C may continuously scan the NFC antenna 40c (specific NFC antenna) at each scan. The NFC control unit 21C may scan in the forward direction a single NFC antenna 40 out of the NFC antennas 40a through 40e excluding the NFC antenna 40c.

Specifically, the NFC control unit 21C simultaneously scans two NFC antennas 40 in the order “c·a→c·b→c·d→c·e”. In this way, the NFC control unit 21C may continuously scan a specific NFC antenna 40 out of multiple NFC antennas 40.

FIG. 9(a) illustrates the case in which the NFC antenna 40c (the specific NFC antenna) and the NFC antenna 40a (the NFC antenna 40 serving as a target for sequential scanning) are simultaneously scanned. Referring to FIG. 9(a), the NFC tag 100 moving in the opposite direction is positioned in close proximity with the NFC antenna 40d.

FIG. 9(b) illustrates the timing that is two scan steps later than the timing in FIG. 9(a). Referring to FIG. 9(b), the NFC antenna 40c (the specific NFC antenna) and the NFC antenna 40d (NFC antenna serving as a target for sequential scanning) are simultaneously scanned. Referring to FIG. 9(b), the NFC tag 100 moving in the opposite direction is positioned in close proximity with the NFC antenna 40c.

By continuously scanning the NFC antenna 40c, the communication coverage area D3 is continuously formed on the NFC display 10A. Communication with the NFC tag 100 moving in the opposite direction is thus enabled in the communication coverage area D3. Continuously scanning the specific NFC antenna may reduce the possibility that the NFC tag 100 passes through the communication coverage areas D1 through D5.

In the third embodiment, the single specific NFC antenna is used for convenience of explanation. Alternatively, multiple NFC antennas 40 may be used. The specific NFC antenna is not limited to the NFC antenna 40c. The designer of the information processing apparatus 1D may appropriately set which of the NFC antennas 40 to be the specific NFC antenna 40.

When the NFC control unit 21C simultaneously scans at least two NFC antennas 40, at least one of the two NFC antennas 40 is continuously scanned.

The NFC control unit 21C may select the specific NFC antenna 40 having the highest communication reliability with the NFC tag 100 from among the NFC antennas 40a through 40e.

### SECOND MODIFICATION

In accordance with the third embodiment, multiple NFC antennas 40 are regularly linearly arranged on the NFC display 10A. The scanning method of the NFC antennas 40 of the third embodiment may be applied to an NFC display 10C having the multiple NFC antennas 40 that are regularly linearly arranged.

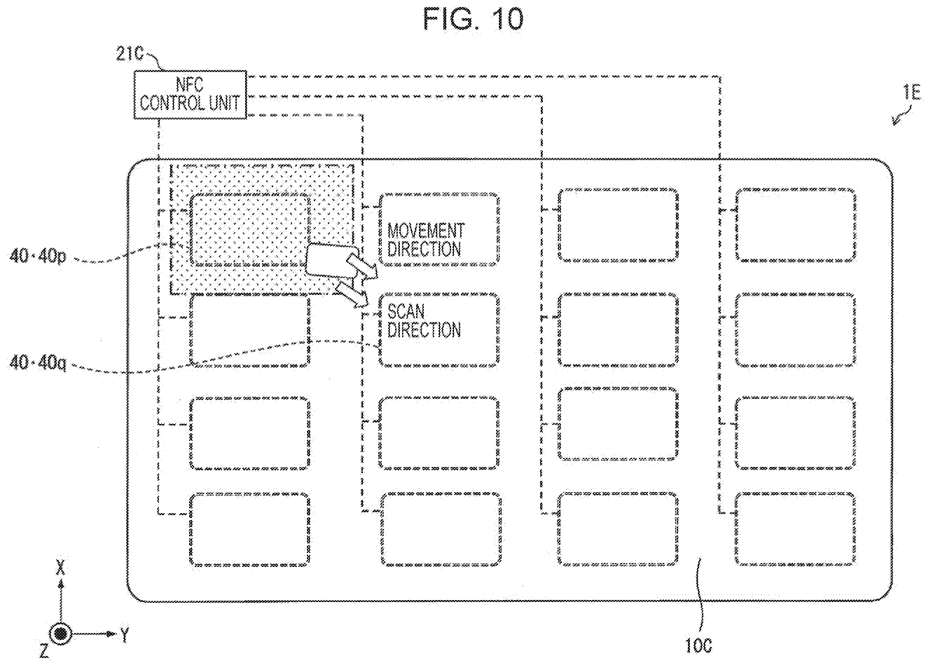

FIG. 10 illustrates an information processing apparatus 1E as a modification of the information processing apparatus 1D. The information processing apparatus 1E includes the NFC display 10C in place of the NFC display 10A in the information processing apparatus 1D. Referring to FIG. 10, the NFC display 10C includes 16 NFC antennas 40 which are regularly two-dimensionally arranged in a matrix of 4×4.

For convenience of explanation, the NFC antenna 40 positioned at the top left corner of the page of FIG. 10 is referred to as an NFC antenna 40p. The NFC antenna 40 that is at a diagonally spaced position, namely, spaced rightward by one NFC antenna from the NFC antenna 40p and spaced downward by one NFC antenna from the NFC antenna 40p at the same time is referred to as an NFC antenna 40q. The NFC antenna 40q is the antenna that is closest to the NFC antenna 40p in a right-downward direction.

FIG. 10 illustrates the case in which the NFC tag 100 moves in the right-downward direction (in a direction moving from the NFC antenna 40p to the NFC antenna 40q). Referring to FIG. 10, the right-downward direction is set to be the forward direction. In the same process as in the third embodiment, the NFC control unit 21C in the information processing apparatus 1E may estimate the terminal movement direction to the forward direction.

The NFC control unit 21C may set the scan direction to the NFC antennas 40 to be the forward direction (right-downward direction). Since the information processing apparatus 1E scans the NFC antennas 40 keeping track of the movement of the NFC tag 100, the information processing apparatus 1E may more reliably perform communications with the NFC tag 100.

Referring to FIG. 9, the information processing apparatus 1E may also continuously scan a specific NFC antenna 40. For example, an NFC antenna 40 predicted to have higher communication reliability with the NFC tag 100 may be selected as the specific NFC antenna 40. In this way, the information processing apparatus 1E may more reliably communicate with the NFC tag 100.

For example, if the user may be expected to have a higher frequency of holding the NFC tag 100 over the NFC antenna 40p, the NFC antenna 40p may be selected as the specific NFC antenna.

If communication has not been performed between the information processing apparatus 1E and the NFC tag 100, NFC antennas 40 (for example, the NFC antenna 40 to the immediate right of the NFC antenna 40p, the NFC antenna 40 immediately below the NFC antenna 40p, and the NFC antenna 40q) positioned in the vicinity of (surrounding) the specific NFC antenna (for example, the NFC antenna 40p) may be scanned with a higher priority (with a higher frequency) than other NFC antennas 40.

Even if the NFC tag 100 is not positioned at a position where communications with the NFC antenna 40p (the specific NFC antenna) are possible, the probability that the NFC tag 100 is positioned in close proximity with the NFC antenna 40p is still expected to be higher than the probability that the NFC tag 100 is positioned farther from the NFC antenna 40p.

### [Implementation Example Using Software]

The control block of the information processing apparatuses 1A through 1E (particularly, the control unit 20 and the NFC control units 21A through 21C) may be implemented using logic circuit (hardware) formed on an integrated circuit (IC chip) or may be implemented by a CPU (Central Processing Unit) and software.

In the latter case, each of the information processing apparatuses 1A through 1E includes a CPU that executes a program as software that implements functions of the apparatuses, a ROM (Read Only Memory) or a memory device (each of these is referred to as a “recording media”) that records the program and a variety of data in a computer-readable (or CPU-readable) way, and a RAM (Random Access Memory) on which the program is expanded. The object of the disclosure is accomplished when the computer (or CPU) reads the program from the recording medium and executes the read program. The recording medium includes a “non-transitory physical media”, such as tape, disk, card, semiconductor memory, or programmable logic circuit. The program may be supplied to the computer via any transmission medium capable of transmitting the program (such as a communication network or broadcast wave). An aspect of the disclosure may also be implemented by a data signal that is implemented by electronically transmitting the program and is embedded in a carrier wave.

The information processing apparatus of each of the embodiments of the disclosure may be implemented by a computer. A control program of the information processing apparatus causes a computer to operate as elements (software elements) in the information processing apparatus and the information processing apparatus is thus implemented by the computer. Such a computer program and a computer readable recording program having recording the program fall within the scope of the disclosure.

### CONCLUSION

According to a first aspect of the disclosure, an information processing apparatus with a plurality of antennas used to perform near field communication with an information communication terminal includes a scan controller that controls a sequential order in accordance with which the antennas are scanned.

Since the scanning sequential order of the antennas is controlled in view of the applications of the information processing apparatus in this configuration, the communications with the information communication terminal are more reliably performed.

According to a second aspect of the disclosure in view of the first aspect, in the information processing apparatus in, the scan controller may control the sequential order such that an overlapping region between a communication coverage area of the antenna that is currently being scanned and a communication coverage area of the antenna that has been scanned immediately before is minimized.

In the configuration described above, the antenna that is currently being scanned and the antenna that has been scanned immediately before are used to increase the area of detection to detect the information communication terminal. As a result, the possibility that the information processing apparatus detects the information communication terminal is increased and the possibility that the information processing apparatus detects earlier the information communication terminal is increased. The communications with the information communication terminal are more reliably performed.

According to a third aspect of the disclosure in view of one of the first and second aspects, the information processing apparatus may further include a frequency-of-scanning determination unit that determines a frequency of scanning of each of the antennas. The scan controller may control the sequential order in accordance with the frequency of scanning determined by the frequency-of-scanning determination unit.

In the configuration described above, the frequency of scanning may be modified in view of the usage status and applications of the information processing apparatus if already known. In this way, the possibility that the information processing apparatus detects the information communication terminal is increased and the possibility that the information processing apparatus detects earlier the information communication terminal is increased. The communications with the information communication terminal are more reliably performed.

According to a fourth aspect of the disclosure in view of the third aspect, in the information processing apparatus, the frequency-of-scanning determination unit may determine the frequency of scanning in accordance with a frequency of communications heretofore performed between the antennas and the information communication terminal.

In the configuration described above, the frequency of scanning is determined such that the frequency of scanning of the antenna having a higher frequency of communications is higher and the frequency of scanning of the antenna having a higher frequency of communications is lower. In this way, the possibility that the information processing apparatus detects earlier the information communication terminal is increased.

According to a fifth aspect of the disclosure in view of one of first through fourth aspects, the information processing apparatus may further include an estimator that estimates a direction of movement of the information communication terminal. The scan controller scans the antenna positioned in the direction of movement of the information communication terminal estimated by the estimator.

Since the information processing apparatus scans the antenna, keeping track of the movement of the information communication terminal in the configuration described above, the information communication terminal may more reliably communicate with the information communication terminal. Also, communication time with the information communication terminal may be shortened.

According to a sixth aspect of the disclosure in view of one of the first through fifth aspects, if the scan controller simultaneously scans at least two antennas, the scan controller continuously scans at least one of the two antennas.

In the configuration described above, continuously scanning the antenna having a higher frequency of communications may increase the possibility that the information processing apparatus detects the information communication terminal and may increase the possibility that the information processing apparatus detects earlier the information communication terminal. If the information communication terminal moves in a direction opposite to the scan direction, communications with the NFC tag 100 may be performed within the communication coverage area of the antenna that is continuously scanned. In this way, the possibility that the information communication terminal passes through the communication coverage area may be reduced.

According to a seventh aspect of the disclosure in view of one of the first through fifth aspect, if the scan controller simultaneously scans at least two antennas, the two antennas may be adjacent to each other.

In the configuration described above, the possibility that the information communication terminal passes through the communication coverage area may be reduced more than when non-adjacent antennas are simultaneously scanned.

According to an eight aspect of the disclosure, a control method performed by an information processing apparatus with a plurality of antennas used to perform near field communication with an information communication terminal, includes a scan control step that controls a sequential order in accordance with which the antennas are scanned.

The configuration described above provides the same advantage as that of the first aspect.

According to a ninth aspect of the disclosure, a control program causes a computer to function as the information processing apparatus according to the first aspect. The control program causes the computer as the scan controller.

The disclosure is not limited to the embodiments described above. A variety of modifications are possible within the scope described in the claims and an embodiment that is implemented by combining technical units disclosed in each of the different embodiments also falls within the technical scope of the present invention. A new technical feature may be provided by combining the technical units disclosed in each of the different embodiments.

### CROSS-REFERENCES TO RELATED APPLICATIONS

This application claims priority from Japanese Patent Application No. 2017-111650 filed Jun. 6, 2017, the disclosure of which is hereby incorporated herein by reference.

### REFERENCE SIGNS LIST

| | |
|---|---|
| 1A through 1E | Information processing apparatuses |
| 40, 40a through 40h, 40p, and 40q | NFC antennas(antennas) |
| 21A through 21C | NFC control unit (scan controller, |
| | frequency-of-scanning determination |
| | unit, estimator) |
| 100 | NFC tag (information communication |
| | terminal) |
| D1 through D8 | Communication coverage areas |

1. An information processing apparatus with a plurality of antennas used to perform near field communication with an information communication terminal, comprising
a scan controller that controls a sequential order in accordance with which the antennas are scanned.

2. The information processing apparatus according to claim 1, wherein the controller controls the sequential order such that an overlapping region between a communication coverage area of the antenna that is currently being scanned and a communication coverage area of the antenna that has been scanned immediately before is minimized.

3. The information processing apparatus according to claim 1, further comprising a frequency-of-scanning determination unit that determines a frequency of scanning of each of the antennas,
wherein the scan controller controls the sequential order in accordance with the frequency of scanning determined by the frequency-of-scanning determination unit.

4. The information processing apparatus according to claim 3, wherein the frequency-of-scanning determination unit determines the frequency of scanning in accordance with a frequency of communications heretofore performed between the antennas and the information communication terminal.

5. The information processing apparatus according to claim 1, further comprising an estimator that estimates a direction of movement of the information communication terminal,
wherein the scan controller scans the antenna positioned in the direction of movement of the information communication terminal estimated by the estimator.

6. The information processing apparatus according to claim 1, wherein if the scan controller simultaneously scans at least two antennas, the scan controller continuously scans at least one of the at least two antennas.

7. The information processing apparatus according to claim 1, wherein if the scan controller simultaneously scans at least two antennas, the at least two antennas are adjacent to each other.

8. A control method performed by an information processing apparatus with a plurality of antennas used to perform near field communication with an information communication terminal, the control method comprising
a scan control step that controls a sequential order in accordance with which the antennas are scanned.

9. (canceled)

10. A computer-readable recording medium containing a control program for causing a computer to operate as an information processing apparatus with a plurality of antennas used to perform near field communication with an information communication terminal,
the program causing the computer to operate as a scan controller that controls a sequential order in accordance with which the antennas are scanned.
